(19) United States
(12) Patent Application Publication
(10) Pub. No.: US 2005/0001186 A1
(43) Pub. Date: Jan. 6, 2005

(54) Automatic water shut off valve

(75) Inventor: Marc Robert Therriault, carleton place (CA)

Correspondence Address: MARC R THERRIAULT, 333 JOSEPH STREET UNIT 14, CARLETON PLACE, ONTARIO, K7C 3Z5, CA

(73) Assignee: Marc Robert Therriault, Carleton Place (CA)

(21) Appl. No.: 10/604,221

(22) Filed: Jul. 1, 2003

(51) Int. Cl. F16K 31/02

(52) U.S. Cl. 251/129.04

(57) ABSTRACT

A system for eliminating serious water bursts comprises of a main circuit box that can be activated by an alarm system, hard wire, wireless or by switch. Once the alarm system or switch is armed the main circuit box will send a signal to activate a solenoid valve that is interposed in a water main acting to stop water flow.

### BACKGROUND OF INVENTION

Wherever water is held under pressure, there is the prospect of a leak or rupture of a water line. While leaks and ruptures are not frequent occurences, if there is no one present to stop the water flow then this may result in severe water damage.The subject of the invention addresses this problem.

### SUMMARY OF INVENTION

According to the present invention, there is provided a system for shuting off fluid flow by a shut-off valve for interposition in the fluid line, a valve curciut box for said valve, said curcuit box is activated by switch such as light switch or by alarm system auxilary outputs or by wireless alarm system using RF module to control said curcuit box, wich will activate said valve to shut off said fluid flow.

### BRIEF DESCRIPTION OF DRAWINGS

In the figure wich illustrates example embodiment of the invention:

FIG. 1 is a schematic representation of a system made in accordance with the invention

### DETAILED DESCRIPTION

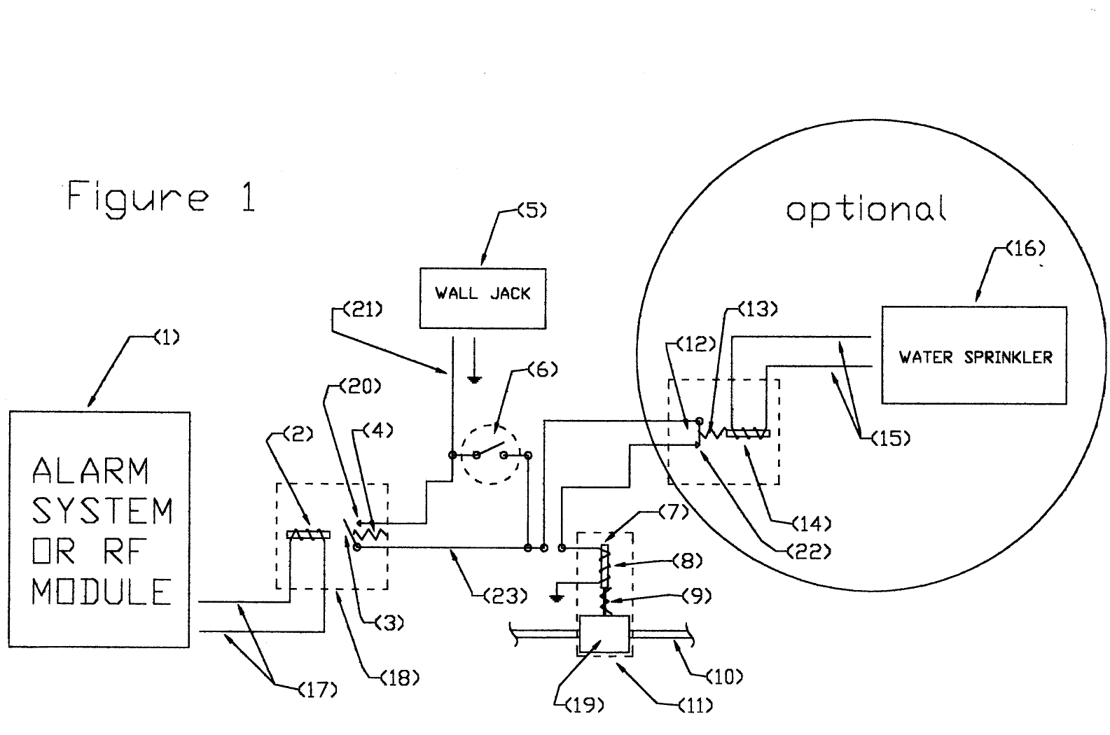

With reference to FIG. 1 in overview system for shutting off water when away from home comprises a shut-off valve (11) interposed in a water line illustrated in phantom (10). A controller for the valve is indicated at (18). The valve controller (16) is coupled a power conector (5) through an alarm system or RF module (1) or by manual switch (6) Valve (11) is a normally open solenoid valve. The valve comprises a valve body (19) connected to a solenoid core (7) which is surrounded by a solenoid coil (8). Solenoid core (7) and therefore the valve body (19) is biased by spring (9) to a valve open position, as illustrated in figure. the valve controller (18) comprises a magnetic coil (2) biased by spring (4) to a first position where at the blade (3) of the relay contacts contact (20) as illustrated in FIG. 1. The connector (21) comprises a pair of connectors for connecting with alternating current source of power such as household supply.

When person leaves home they will arm their alarm system, or turn on manual water shut off switch. When the alarm is armed it will send out a constant DC voltage to line (17) energizing coil (2) forcing blade (3) to connect with contact (20) this will connect power line (21) with line (23) this will send power to coil (8) solenoid valve will compress spring (9) shutting off water in line (10). When alarm system is turned off power is cut to coil (2) breaking the circuit from power supply (5) and solenoid coil (8), the normally open solenoid valve spring (9) will then uncompress allowing water to flow. If manually activated by switch power line (21) will be connected directly to solenoid coil (8) through switch (6) once again closing the normally open valve (11) when deactivated by switch (6) the circuit will be broken allowing the normally open valve to open.

Optional water sprinkler circuit breaker, as show in FIG. 1, if occupants have armed the water protection system water is shut off. In the event that water sprinkler must be activated, this feature will make it possible. Water sprinkler (16) will send power to coils (14) moving blade (12) opening connection (22) which will open the closed circuit to solenoid valve coil (8) the solenoid valve will open allowing water to flow.

If power is lost at anytime for reason such as storm, power outage, the water will remain on. This will ensure that in such an event, the occupants will still have running water.

1. A system for shutting off residents water supply when occupants are not present comprising:-a shut-off valve for interposition in water main;-a valve controller for said valve;-a connector for connecting to a source of electrical power connected to said valve controller;-a said valve biased to a valve open position;-a system wherein said valve controller is arranged to close said valve when alarm system or manual switch is activated;-a system with optional sprinkler circuit breaker acting to turn water on when sprinkle is on;
